(19) United States
(12) Patent Application Publication
(10) Pub. No.: US 2021/0109531 A1
(43) Pub. Date: Apr. 15, 2021

(54) TRAJECTORY GENERATOR, TRAJECTORY GENERATING METHOD AND NON-TRANSITORY TANGIBLE COMPUTER-READABLE STORAGE MEDIUM

(71) Applicant: DENSO CORPORATION, Kariya-city (JP)

(72) Inventors: Isao OOKAWA, Kariya-city (JP); Kenichiro NONAKA, Tokyo (JP)

(21) Appl. No.: 17/065,999

(22) Filed: Oct. 8, 2020

(30) Foreign Application Priority Data
Oct. 10, 2019 (JP) 2019-186954

(51) Int. Cl. G05D 1/02; G05D 1/08; B60W 30/10

(52) U.S. Cl. CPC G05D 1/0212; G05D 1/0891; B60W 2420/90; G05D 2201/0213; B60W 30/10

(57) ABSTRACT

A physical quantity of motion of a vehicle in future traveling is specified in time series in a traveling trajectory. A standard trajectory is calculated based on a standard response parameter as a traveling trajectory that does not consider a constraint condition in future traveling. A correction trajectory is calculated based on a correction response parameter different from the standard trajectory as a traveling trajectory having a correction amount for correcting the standard trajectory in time series according to the constraint condition. A target trajectory to which the vehicle follows is calculated as a traveling trajectory in which the correction trajectory is superimposed on the standard trajectory.

### CROSS REFERENCE TO RELATED APPLICATIONS

The present application claims the benefit of priority from Japanese Patent Application No. 2019-186954 filed on Oct. 10, 2019. The entire disclosure of the above application is incorporated herein by reference.

### TECHNICAL FIELD

The present disclosure relates to a technique for generating a travelling trajectory in which a physical quantity of motion in future travelling of a vehicle is specified in time series.

### BACKGROUND

Conventionally, a technique for generating a traveling trajectory which a vehicle follows in future driving has been proposed, for example. In the technology, the standard trajectory based on the traffic lane information is corrected by the constraint information to generate the traveling trajectory of the vehicle to follow.

### SUMMARY

A physical quantity of motion of a vehicle in future traveling is specified in time series in a traveling trajectory. A standard trajectory is calculated based on a standard response parameter as a traveling trajectory that does not consider a constraint condition in future traveling. A correction trajectory is calculated based on a correction response parameter different from the standard trajectory as a traveling trajectory having a correction amount for correcting the standard trajectory in time series according to the constraint condition. A target trajectory to which the vehicle follows is calculated as a traveling trajectory in which the correction trajectory is superimposed on the standard trajectory.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing an overall configuration of a trajectory generator according to an embodiment;

FIG. 2 is a block diagram showing a detailed configuration of a trajectory generator according to the embodiment;

FIG. 3 is a schematic diagram for explaining a traveling trajectory according to the embodiment;

FIG. 4 is a schematic diagram for explaining a standard trajectory according to the embodiment;

FIG. 5 is a schematic diagram for explaining a constraint condition according to the embodiment;

FIG. 6 is a graph for comparing a standard trajectory and a correction trajectory according to the embodiment;

FIG. 7 is a schematic diagram for explaining a correction trajectory according to the embodiment;

FIG. 8 is a schematic diagram for explaining a target trajectory according to the embodiment;

FIG. 9 is a schematic diagram for explaining vehicle control that follows a target trajectory according to the embodiment;

FIG. 10 is a flowchart illustrating a trajectory generating method according to the embodiment; and

FIG. 11 is a graph for comparing the effect of the embodiment (a) with the comparative example (b).

### DETAILED DESCRIPTION

In a conceivable technique, one of multiple types in the constraint information is reflected on the standard trajectory one by one. Therefore, when the number of predicted points on the standard trajectory is defined as N, the maximum number of calculations required to generate the final traveling trajectory may reach 2N or more.

According to the above point, a trajectory generator is provided such that reduces a calculation load for generating a traveling trajectory. Further, a trajectory generation method is provided such that reduces a calculation load for generating a traveling trajectory. Further, a trajectory generation program is provided such that reduces the calculation load for generating a traveling trajectory.

According to an example embodiment, a trajectory generator (1) for generating a traveling trajectory (X) in which a physical quantity of motion of a vehicle (3) in future traveling is specified in time series, the trajectory generator includes:
a standard calculator (100) that calculates a standard trajectory (X_{b}) based on a standard response parameter (Q_{b}, R_{b}) as a traveling trajectory that does not consider a constraint condition in the future traveling;
a correction calculator (140) that calculates a correction trajectory (Xm) based on a correction response parameter (Qₘ, Rₘ) different from the standard trajectory as a traveling trajectory having a correction for correcting the standard trajectory in time series according to the constraint condition; and
a target calculator (160) that calculates a target trajectory (Xₚ) to be followed by the vehicle as a traveling trajectory in which the correction trajectory is superimposed on the standard trajectory.

According to an example embodiment, a trajectory generating method executed by a processor (12) for generating a traveling trajectory (X) in which a physical quantity of motion of a vehicle (3) in future traveling is specified in time series, the trajectory generating method includes:
calculating a standard trajectory (X_{b}) based on a standard response parameter (Q_{b}, R_{b}) as a traveling trajectory that does not consider a constraint condition in the future traveling (S101);
calculating a correction trajectory (Xₘ) based on a correction response parameter (Qₘ, Rₘ) different from the standard trajectory as a traveling trajectory having a correction for correcting the standard trajectory in time series according to the constraint condition (S103); and
calculating a target trajectory (Xₚ) to be followed by the vehicle as a traveling trajectory in which the correction trajectory is superimposed on the standard trajectory (S104).

According to an example embodiment, a trajectory generating program that includes instructions executed by a processor (12) and is stored in a storage medium (10) to generate a traveling trajectory (X) in which a physical quantity of motion of a vehicle (3) in future traveling is specified in time series, the instructions includes:
calculating a standard trajectory (X_{b}) based on a standard response parameter (Q_{b}, R_{b}) as a traveling trajectory that does not meet a constraint condition in the future traveling (S101);
calculating a correction trajectory (Xₘ) based on a correction response parameter (Qₘ, Rₘ) different from the standard trajectory as a traveling trajectory having a correction for correcting the standard trajectory in time series according to the constraint condition (S103); and
calculating a target trajectory (Xₚ) to be followed by the vehicle as a traveling trajectory in which the correction trajectory is superimposed on the standard trajectory (S104).

According to these embodiments, the standard trajectory without considering the constraint condition in the future traveling is corrected by the correction amount of the travelling trajectory in time series according to the constraint condition, and the correction trajectory is calculated based on the response parameter different from the standard trajectory. As a result, the constraint condition can be reflected at once in the calculation of the correction trajectory regardless of the type thereof. Therefore, it becomes possible to reduce the calculation load until the target trajectory is generated by superimposing the correction trajectory on the standard trajectory.

Hereinafter, an embodiment will be described with reference to the drawings.

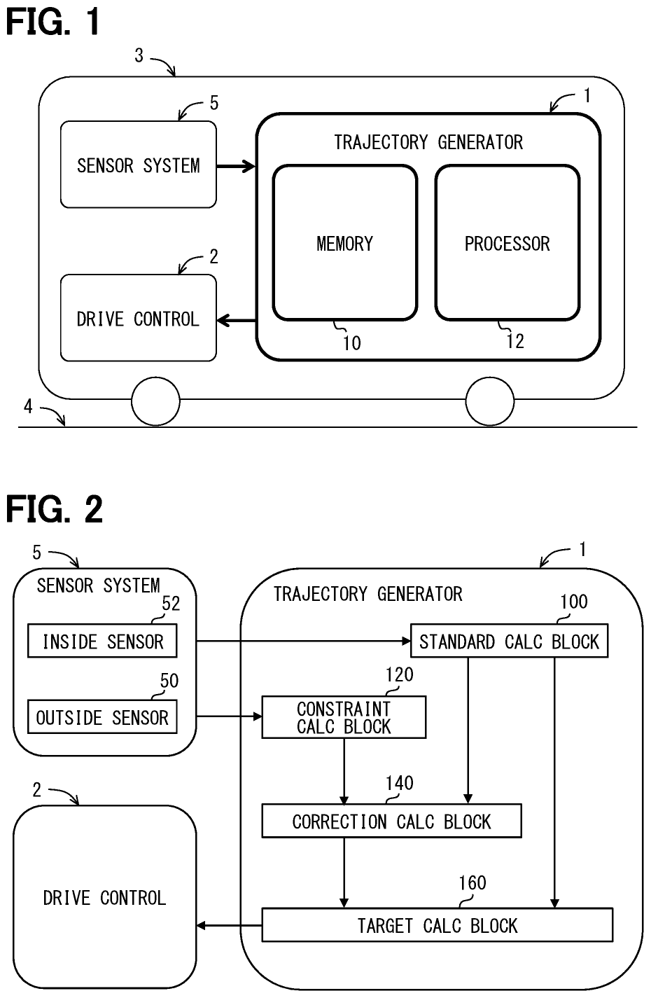

As shown in FIG. 1, a trajectory generator 1 according to an embodiment is mounted on a vehicle 3 together with a driving control device 2. The trajectory generator 1 generates a traveling trajectory to be followed in the future traveling by the vehicle 3. The driving control device 2 executes a driving control on the vehicle 3 to follow the traveling trajectory generated by the trajectory generator 1. The vehicle 3 is, for example, an automatic driving vehicle or an advanced driving assistance vehicle that can autonomously travel on the driving path 4 steadily or temporarily by receiving the driving control from the driving control device 2.

A sensor system 5 is mounted on the vehicle 3 in addition to the trajectory generator 1 and the driving control device 2. The sensor system 5 acquires various kinds of information that can be utilized for the trajectory generation by the trajectory generator 1 and for the driving control by the driving control device 2. As shown in FIG. 2, the sensor system 5 includes an outside sensor 50 and an inside sensor 52.

The outside sensor 50 generates information about the outside of the vehicle 3, which is the surrounding environment of the vehicle 3. The outside sensor 50 may acquire the outside information by detecting an object existing in the outside of the vehicle 3. The outside sensor 50 of the detection type is at least one of a camera, a LIDAR (Light Detection and Ranging/Laser Imaging Detection and Ranging), a radar, a sonar, and the like, for example.

The outside sensor 50 may acquire the external information by receiving a signal from an artificial satellite of a GNSS (Global Navigation Satellite System) disposed in the outside of the vehicle 3 or a signal from a roadside device of ITS (Intelligent Transport Systems).

The outside sensor 50 of the reception type is at least one of, for example, a GNSS receiver, a telematics receiver, and the like.

The inside sensor 52 generates information about the inside of the vehicle 3, which is the internal environment of the vehicle 3. The inside sensor 52 may generate the internal information by detecting a specific motion physical quantity in the inside of the vehicle 3. The detection type inside sensor 52 is, for example, at least one of a gyroscope, a traveling speed sensor, an acceleration sensor, a steering angle sensor, and the like.

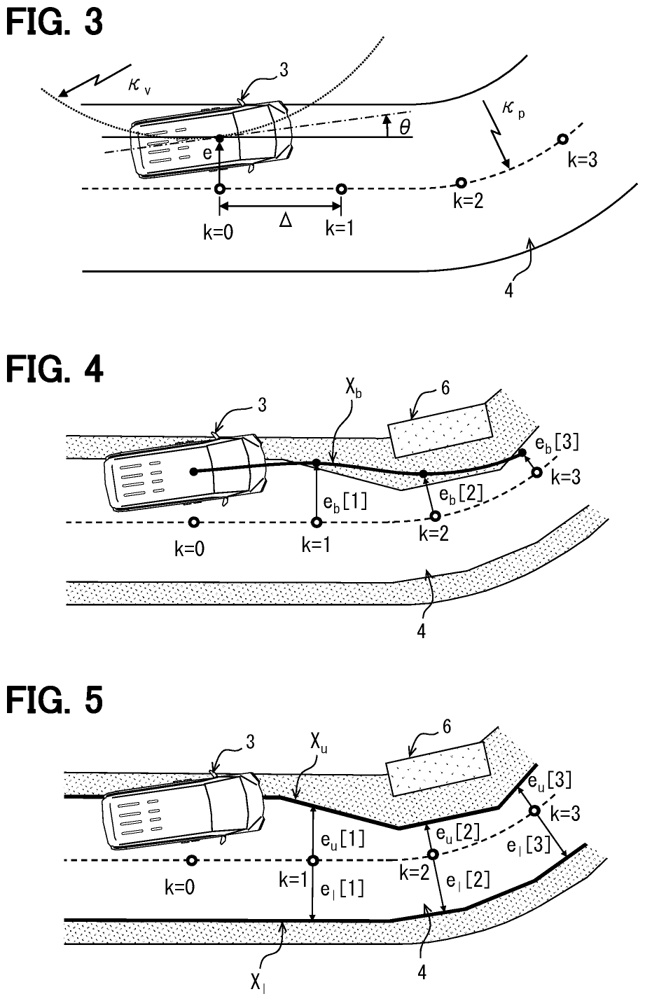

Based on the acquired information of the sensor system 5, the travel trajectory generated by the trajectory generator 1 and output to the driving control device 2 defines the physical quantity of motion of the vehicle 3 in future travel in time series. Specifically, the travelling trajectory is generated in a region from the current time-series point to the future time-series point, which is set ahead of the current time-series point by the predetermined number of steps, as the future prediction region. That is, the time-series points on the travelling trajectory indicated by white circles in FIG. 3 are predicted points for providing the travelling trajectory. When each time series point included in the future prediction region is identified by the index k, the current time series point at the present time is defined as k=0, and the future time series point ahead of the current time-series point by the predetermined number of steps is defined as k=N, the current time series point provides a starting point and the future time series point provides an end point of the travelling trajectory.

The travel trajectory defines a vector value or a scalar value at each time series point in the future prediction region so as to give a desired response characteristic with respect to a specific physical motion quantity of various physical motion quantities of the vehicle 3. The physical quantity of motion of the vehicle 3 defined by the travelling trajectory is at least one of a lateral position or a yaw angle, a running speed, an acceleration, a travelling distance, a steering angle, and the like relative to the travelling path 4. Here, in order to facilitate understanding, the present embodiment will be described below by describing an example of the case where the trajectory generator 1 generates a traveling trajectory in a lateral position relative to the traveling path 4. The lateral position relative to the traveling path 4 is defined as the relative position from the center position (see the broken line in FIG. 3) in the width direction of the traveling path 4, and is simply referred to as the lateral position in the following description. Further, the yaw angle relative to the traveling path 4 is defined as a relative angle between the center line of the traveling path 4 and the center line (see the dash-dotted line in FIG. 3) in the width direction of the vehicle 3, and will be simply described in the following description as the yaw angle.

When the lateral position and the yaw angle at time k are represented by e[k] and θ[k], respectively, the following equation 1 is approximately established between the lateral position and the yaw angle. In equation 1, kₚ[k] is the curvature of the traveling path 4. In equation 1, kᵥ[k] is a curvature that the vehicle 3 should follow. In equation 1, Δ is a time interval between time series points. Under the condition that equation 1 is satisfied, the traveling trajectory X at that position is defined by the following equation 2 using the lateral position e[k] at each time series point where k is 1 to N.

$$\begin{matrix}( Equations 1 and 2 ) & \\ [ \begin{matrix}e [ k + 1 ] \\ θ [ k + 1 ]\end{matrix} ] = [ \begin{matrix}1 & Δ \\ 0 & 1\end{matrix} ] \cdot [ \begin{matrix}e [ k ] \\ θ [ k ]\end{matrix} ] + [ \begin{matrix}{Δ}^{2} / 2 \\ Δ\end{matrix} ] \cdot ( {κ}_{v} [ k ] - {κ}_{p} [ k ] ) & 1 \\ X = {[ e [ 1 ] , e [ 2 ] , … , e [ N ] ]}^{T} & 2\end{matrix}$$

Here, “ [symbol] ” in an equation means “Equation.”

Then the state quantity x[k] representing the motion state of the vehicle 3 and the operation quantity u[k] representing the driving operation of the vehicle 3 are defined by the following equations 3 and 4, respectively, the equation 1 is linearly approximated by the following equations 5 to 7. Under this approximation, the evaluation index J regarding the traveling trajectory X at the lateral position e[k] in the future prediction region is represented by the following equation 8. In equation 8, the parameter matrix Q is a response parameter that adjusts the action of causing the traveling trajectory X to approach the central position in the width direction of the traveling path 4. In equation 8, the parameter coefficient R is a response parameter that adjusts the degree of steepness in the change of the traveling trajectory X. The evaluation index J expressed by the equation 8 specifies the response characteristic of the traveling trajectory X that is determined according to the settings of the parameter matrix Q and the parameter coefficient R. The center position in the width direction of the traveling path 4 is simply referred to as the center position in the following description.

$$\begin{matrix}( Equations 3 to 8 ) & \\ x [ k ] = {[ e [ k ] , θ [ k ] ]}^{T} & 3 \\ u [ k ] = {κ}_{v} [ k ] - {κ}_{p} [ k ] & 4 \\ x [ k + 1 ] = A \cdot x [ k ] + b \cdot u [ k ] & 5 \\ A = [ \begin{matrix}1 & Δ \\ 0 & 1\end{matrix} ] & 6 \\ b = [ \begin{matrix}{Δ}^{2} / 2 \\ Δ\end{matrix} ] & 7 \\ J = \frac{1}{2} \cdot {x [ N ]}^{T} \cdot Q \cdot {x [ N ]}^{T} + \frac{1}{2} \cdot {\sum }_{k = 0}^{N - 1} ( {x [ k ]}^{T} \cdot Q \cdot {x [ k ]}^{T} + R \cdot {u [ k ]}^{2} ) & 8\end{matrix}$$

When the traveling trajectory U of the operation quantity u[k] is defined by the equation 9 using the operation quantity u[k] at each time series point with setting k from 0 to N−1, the equations 5 and 8 are rearranged, so that the following equations 10 to 12 are obtained. That is, the evaluation index J regarding the traveling trajectory X at the lateral position e[k] in the future prediction region may also be expressed by equation 10 by substituting equations 11 and 12 into equation 10.

$$\begin{matrix}[ Equations 9 to 12 ] & \\ U = {[ u [ 0 ] , u [ 1 ] , … , u [ N - 1 ] ]}^{T} & 9 \\ J = \frac{1}{2} \cdot {U}^{T} \cdot H ( Q , R ) \cdot U + {U}^{T} \cdot F ( Q ) \cdot x [ 0 ] & 10 \\ H ( Q , R ) = {[ \begin{matrix}b & 0 & ⋯ & 0 \\ A \cdot b & b & ⋯ & 0 \\ ⋮ & ⋮ & ⋱ & ⋮ \\ {A}^{N - 1} \cdot b & {A}^{N - 2} \cdot b & ⋯ & b\end{matrix} ]}^{T} \cdot [ \begin{matrix}Q & ⋯ & 0 \\ ⋮ & ⋱ & ⋮ \\ 0 & ⋯ & Q\end{matrix} ] \cdot [ \begin{matrix}b & 0 & ⋯ & 0 \\ A \cdot b & b & ⋯ & 0 \\ ⋮ & ⋮ & ⋱ & ⋮ \\ {A}^{N - 1} \cdot b & {A}^{N - 2} \cdot b & ⋯ & b\end{matrix} ] + [ \begin{matrix}R & ⋯ & 0 \\ ⋮ & ⋱ & ⋮ \\ 0 & ⋯ & R\end{matrix} ] = {\overline{B}}^{T} \cdot \overline{Q} ( Q ) \cdot \overline{B} + \overline{R} ( R ) & 11 \\ F ( Q ) = {[ \begin{matrix}b & 0 & ⋯ & 0 \\ A \cdot b & b & ⋯ & 0 \\ ⋮ & ⋮ & ⋱ & ⋮ \\ {A}^{N - 1} \cdot b & {A}^{N - 2} \cdot b & ⋯ & b\end{matrix} ]}^{T} \cdot [ \begin{matrix}Q & ⋯ & 0 \\ ⋮ & ⋱ & ⋮ \\ 0 & ⋯ & Q\end{matrix} ] \cdot [ \begin{matrix}A \\ {A}^{2} \\ ⋮ \\ {A}^{N}\end{matrix} ] = {\overline{B}}^{T} \cdot \overline{Q} ( Q ) \cdot \overline{A} & \end{matrix}$$

In order to generate the travelling trajectory X having the highest evaluation index J (that is, the minimum in equations 8 and 10), the trajectory generator 1 shown in FIG. 1 includes at least one ECU (Electronic Control Unit). The ECU configuring the trajectory generator 1 may be an locator ECU that estimates the self-position of the vehicle 3 or an ECU that controls communication between the vehicle 3 and the external system.

In the case of these ECUs, the trajectory generator 1 is connected to the driving control device 2 and the sensor system 5 via at least one of a LAN (Local Area Network), a wire harness, an internal bus, and the like. The ECU that constituting the trajectory generator 1 may be an ECU that also functions as the driving control device 2. In the case of this ECU, the trajectory generator 1 is connected to the sensor system 5 via at least one of a LAN, a wire harness, an internal bus, and the like.

The trajectory generator 1 is a special purpose computer including at least one memory 10 and at least one processor 12. The memory 10 is at least one type of non-transitory tangible storage medium, such as a semiconductor memory, a magnetic storage medium, and an optical storage medium, for non-transitory storing or memorizing computer readable programs and data. The processor 12 includes, as a core, at least one type of, for example, a CPU (Central Processing Unit), a GPU (Graphics Processing Unit), an RISC (Reduced Instruction Set Computer) CPU, and so on. The processor 12 executes a plurality of instructions included in the trajectory generation program stored in the memory 10.

Thereby, the trajectory generator 1 establishes a plurality of functional blocks for generating the traveling trajectory X. As described above, in the trajectory generator 1, the trajectory generation program stored in the memory 10 causes the processor 12 to execute a plurality of instructions in order to generate the traveling trajectory X, and thus a plurality of functional blocks are constructed.

As shown in FIG. 2, the plurality of functional blocks constructed by the trajectory generator 1 include a standard calculation block 100, a constraint calculation block 120, a correction calculation block 140, and a target calculation block 160.

The standard calculation block 100 calculates a standard trajectory X_{b} based on a standard response parameter as a traveling trajectory X that does not consider the constraint condition (detailed later) in the future traveling of the vehicle 3. Specifically, the standard calculation block 100 sets the parameter matrix Q_{b} and the parameter coefficient R_{b} for calculating the standard trajectory X_{b} as the parameter matrix Q and the parameter coefficient R which are the response parameters in the equation 10 representing the evaluation index J. The parameter matrix Q_{b} and the parameter coefficient R_{b} are set to be appropriate values that satisfy the equations 13 and 14, respectively, by, for example, an experimental result or a simulation result, or an operation for each time point based on these results. Equation 13 is a conditional equation for setting a condition that the parameter matrix Q_{b} is a positive semi-definite matrix.

[Equations 13 and 14]

Q_{b}≥0 [symbol] 13

R_{b}>0 [symbol] 14

Under the setting of the parameter matrix Q_{b} and the parameter coefficient R_{b}, the standard calculation block 100 calculates the travelling trajectory U_{b} of the operation variable u_{b}[k], with which the evaluation index J with respect to the standard trajectory X_{b} is the highest, by the following equation 15. The standard calculation block 100 calculates the standard trajectory X_{b} of the lateral position e_{b}[k] where the standard evaluation index J is the highest, using the calculation results of the traveling trajectory U_{b} according to the following equations 16 and 17. In the calculation of these trajectories U_{b} and X_{b}, the state quantity x[0] of equations 16 and 17 is obtained based on at least the external information of the output information from the sensors 50 and 52. FIG. 4 shows an example of the standard trajectory X_{b} calculated without considering the constraint, together with the lateral position e_{b}[k] at each time series point when the constraint with respect to the vehicle 3 is to avoid the obstacle 6 (details will be described later). Note that, in FIG. 4, the area with dot hatching indicates an area where the vehicle 3 should be substantially restricted.

$$\begin{matrix}[ Equations 15 to 17 ] & \\ {U}_{b} = {[ {u}_{b} [ 0 ] , {u}_{b} [ 1 ] , … , {u}_{b} [ N - 1 ] ]}^{T} = - {H ( {Q}_{b} , {R}_{b} )}^{- 1} \cdot F ( {Q}_{b} ) \cdot x [ 0 ] & 15 \\ {X}_{b} = {[ {e}_{b} [ 1 ] , {e}_{b} [ 2 ] , … , {e}_{b} [ N ] ]}^{T} = E 1 \cdot \overline{A} \cdot x [ 0 ] + {E}_{1} \cdot \overline{B} \cdot {U}_{b} & 16 \\ {E}_{1} = [ \begin{matrix}[ \begin{matrix}1 & 0\end{matrix} ] & & 0 \\ & ⋱ & \\ 0 & & [ \begin{matrix}1 & 0\end{matrix} ]\end{matrix} ] & 17\end{matrix}$$

The constraint calculation block 120 illustrated in FIG. 2 determines a constraint predicted in the future traveling of the vehicle 3, that is, the traveling in the future prediction region. At this time, the constraint calculation block 120 sets at least one of constraints, such as avoidance of the obstacle 6, interaction with another vehicle, and legal driving restriction, as a restriction that affects the travel of the vehicle 3 in the future prediction region. Here, in order to facilitate understanding, the present embodiment will be described below by exemplifying a case where avoidance of the obstacle 6 is determined as a constraint.

As a condition that the constraint calculation block 120 limits the traveling trajectory X according to the determined constraint, the constraint condition regarding the lateral position e[k] at each time series point where k is from 1 to N is defined by the following equation 18. In equation 18, eᵤ[k] and eₗ[k] are the upper limit position and the lower limit position of the lateral position e[k] shown in FIG. 5, respectively. Using the upper limit position eᵤ[k] and the lower limit position eₗ[k] at each time series point where k is 1 to N, the upper limit trajectory Xᵤ and the lower limit trajectory Xₗ of the traveling trajectory X are defined by the equations 19 and 20 under a definition of equation 18, so that the following equations 21 to 24 are obtained. Therefore, the constraint calculation block 120 calculates the upper limit trajectory Xᵤ and the lower limit trajectory Xₗ so that the constraint condition is provided by the equation 21 to which the equation 17 and the equations 22 to 24 are substituted.

$$\begin{matrix}( Equations 18 to 24 ) & \\ {e}_{i} [ k ] ≦ e [ k ] ≦ {e}_{u} [ k ] & 18 \\ {X}_{u} = {[ {e}_{u} [ 1 ] , {e}_{u} [ 2 ] , … , {e}_{u} [ N ] ]}^{T} & 19 \\ {X}_{1} = {[ {e}_{1} [ 1 ] , {e}_{1} [ 2 ] , … , {e}_{1} [ N ] ]}^{T} & 20 \\ \tilde{A} \cdot x [ 0 ] + \tilde{B} \cdot U ≦ {Y}_{u 1} & 21 \\ {Y}_{u 1} = [ \begin{matrix}{X}_{u} \\ - {X}_{1}\end{matrix} ] & 22 \\ \tilde{A} = [ \begin{matrix}{E}_{1} & \overline{A} \\ - {E}_{1} & \overline{A}\end{matrix} ] & 23 \\ \tilde{B} = [ \begin{matrix}{E}_{1} & \overline{B} \\ - {E}_{1} & \overline{B}\end{matrix} ] & 24\end{matrix}$$

Specifically, the constraint calculation block 120 determines the lateral positions of the left and right side limits (that is, the left and right side edges) of the travelling path 4 in the future prediction area based on at least the external information of the output information from the sensors 50 and 52. At the same time, the constraint calculation block 120 determines the presence or absence of the obstacle 6 on the traveling path 4 based on the external information from the outside sensor 50.

When the obstacle 6 is disposed on the left side of the center position of the traveling path 4 (see FIG. 5), the constraint calculation block 120 calculates the lateral position of the obstacle 6 on the travelling path 4 in the future prediction based on the surface information of the left-side obstacle 6 among the external information from the outside sensor 50. Of the calculated lateral positions of the obstacle 6 and the left limit, the constraint calculation block 120 sets the lateral position closer to the vehicle 3 at each time series point to be the upper limit starting position. The constraint calculation block 120 subtracts the sum of the half width and the safety margin width of the vehicle 3 from the set upper limit starting position toward the center position side of the traveling path 4 to determine the upper limit trajectory Xᵤ at each time series point.

On the other hand, when the obstacle 6 does not exist on the left side of the center position of the traveling path 4, the constraint calculation block 120 sets the calculated left side limit lateral position to be the upper limit starting position. The constraint calculation block 120 subtracts the sum of the half width and the safety margin width of the vehicle 3 from the set upper limit starting position toward the center position side of the traveling path 4 to determine the lateral position of the upper limit trajectory Xᵤ at each time series point.

When the obstacle 6 exists on the right side of the center position of the travel path 4, the constraint calculation block 120 executes a process which is prepared by replacing the left side, the upper limit starting position, and the upper limit trajectory Xᵤ with the right side, the lower limit starting position, and the lower limit trajectory Xₗ, respectively, in the above processing in which the obstacle 6 is disposed on the left side. On the other hand, when the obstacle 6 does not exist on the right side of the center position of the traveling path 4, the constraint calculation block 120 executes a process which is prepared by replacing the left side, the upper limit starting position, and the upper limit trajectory Xu with the right side, the lower limit starting position, and the lower limit trajectory Xl, respectively, in the above processing in which the obstacle 6 is not disposed on the left side.

Here, as a constraint condition, when a motion physical quantity of a type different from the lateral position e[k] is additionally considered in addition to the lateral position e[k], equations 17 to 20 and 22 to 24 are modified according to the motion physical quantity. For example, in the equation 1, when the constraint condition regarding the yaw angle θ[k] at each time series point where k is 1 to N is added, the constraint condition is defined by the following equation 25. In equation 25, θᵤ[k] and θₗ[k] are the upper limit angle and the lower limit angle of the yaw angle θ[k], respectively. Under the definition of Equation 25, using the upper limit angle θᵤ[k] and the lower limit angle θₗ[k] at each time series point where k is 1 to N, the upper limit trajectory Θu and the lower limit trajectory Θₗ of the yaw angle θ[k] are defined by the following Equations 26 and 27, respectively. In this case, the following equations 28 to 30 instead of the equations 22 to 24 and the following equation 31 instead of the equation 17 are obtained. Therefore, the constraint calculation block 120 calculates the upper limit trajectories Xᵤ, Θᵤ and lower limit trajectories Xₗ, θₗ so that the constraint conditions regarding the lateral position e[k] and the yaw angle θ[k] are given by the equation 20 to which the equations 28 to 31 are substituted. The specific calculation processing of the upper limit trajectory θᵤ and the lower limit trajectory θₗ is based on the specific calculation processing of the upper limit trajectory Xᵤ and the lower limit trajectory Xₗ described above, and thus the explanation thereof will be omitted.

$$\begin{matrix}[ Equations 25 to 31 ] & \\ {θ}_{1} [ k ] ≦ θ [ k ] ≦ {θ}_{u} [ k ] & 25 \\ {Θ}_{u} = {[ {θ}_{u} [ 1 ] , {θ}_{u} [ 2 ] , … , {θ}_{u} [ N ] ]}^{T} & 26 \\ {Θ}_{l} = {[ {θ}_{l} [ 1 ] , {θ}_{l} [ 2 ] , … , {θ}_{l} [ N ] ]}^{T} & 27 \\ {Y}_{u 1} = [ \begin{matrix}{X}_{u} \\ - {X}_{1} \\ {Θ}_{u} \\ - {Θ}_{1}\end{matrix} ] & 28 \\ \tilde{A} = [ \begin{matrix}{E}_{1} \overline{A} \\ - {E}_{1} \overline{A} \\ {E}_{2} \overline{A} \\ - {E}_{2} \overline{A}\end{matrix} ] & 29 \\ \tilde{B} = [ \begin{matrix}{E}_{1} \overline{B} \\ - {E}_{1} \overline{B} \\ {E}_{2} \overline{B} \\ - {E}_{2} \overline{B}\end{matrix} ] & 30 \\ {E}_{2} = [ \begin{matrix}[ \begin{matrix}0 & 1\end{matrix} ] & & 0 \\ & ⋱ & \\ 0 & & [ \begin{matrix}0 & 1\end{matrix} ]\end{matrix} ] & 31\end{matrix}$$

The correction calculation block 140 shown in FIG. 2 calculates the correction trajectory Xₘ in order to correct the standard trajectory X_{b} calculated by the standard calculation block 100 in time series according to the constraint condition calculated by the constraint calculation block 120. At this time, the correction calculation block 140 calculates a correction trajectory Xₘ based on a response parameter different from that of the standard trajectory X_{b}, as the traveling trajectory X having the lateral position correction amount with respect to the standard trajectory X_{b}.

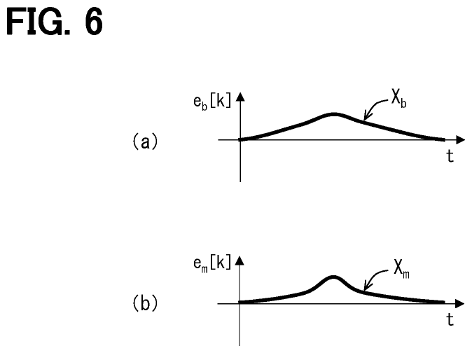

Specifically, the correction calculation block 140 changes the parameter matrix Q and the parameter coefficient R which are the response parameters in the equation 10 representing the evaluation index J from the parameter matrix Q_{b} and the parameter coefficient R_{b} of the standard to the parameter matrix Qₘ and the parameter coefficient Rₘ for calculating the correction trajectory Xₘ. At this time, the correction calculation block 140 sets the parameter matrix Qₘ and the parameter coefficient Rₘ, so as to provide the correction trajectory Xₘ in which the operation quantity u[k] for the vehicle 3 becomes larger than the standard trajectory X_{b}, as a response characteristic that changes the correction trajectory Xₘ to be steeper than the standard trajectory X_{b} as shown in FIG. 6. Setting of the parameter matrix Qₘ and the parameter coefficient Rₘ means the designing of the evaluation index J so that the response characteristic different from that of the standard trajectory X_{b} is more preferable.

In such a setting, the correction calculation block 140 sets the parameter matrix Qₘ and the parameter coefficient Rₘ that satisfy the following equations 32 to 35 so as to provide the evaluation index J in which the N step vector p exists as a condition for satisfying the N step scheme (described in detail later). At this time, when the correction matrix M is defined by the following equation 36 using the parameter matrix Qₘ and the parameter coefficient Rₘ, the correction matrix M for presenting the N step vector p is obtained by setting the parameter matrix Qₘ and the parameter coefficient Rₘ that satisfy the following equation 37. In equation 37, M_{αα} is a submatrix of the correction matrix M corresponding to the index set α. Therefore, equation 37 is a conditional expression that establishes for all index sets α in which the submatrix M_{αα} is a positive definite matrix. In equation 37, p_{α} is a partial vector of the N step vector p corresponding to the index set α. Equation 33 is a conditional equation for setting a condition that the parameter matrix Qₘ is a positive semi-definite matrix.

$$\begin{matrix}( Equations 32 to 37 ) & \\ {Q}_{m} \neq {Q}_{b} & 32 \\ {Q}_{m} ≧ 0 & 33 \\ {R}_{m} \neq {R}_{b} & 34 \\ {R}_{m} > 0 & 35 \\ M = \tilde{B} \cdot {H ( {Q}_{m} , {R}_{m} )}^{- 1} \cdot {\tilde{B}}^{T} = [ \begin{matrix}\overline{M} & - \overline{M} \\ - \overline{M} & \overline{M}\end{matrix} ] & 36 \\ {( {M}_{α α} )}^{- 1} \cdot {p}_{α} > 0 & 37\end{matrix}$$

Under the setting of the parameter matrix Qₘ and the parameter coefficient Rₘ, the correction calculation block 140 calculates the correction trajectory Xₘ of the lateral position correction amount em[k] by the following equation 38 using the correction vector λ. At this time, when the target trajectory Xₚ (detailed later) generated by the target calculation block as the traveling trajectory X is defined by the following equation 39, the correction vector λ which satisfies the following equations 40 to 45 is necessary for calculating the correction trajectory Xₘ.

$$\begin{matrix}( Equations 38 to 45 ) & \\ {X}_{m} = {[ {e}_{m} [ 1 ] , {e}_{m} [ 2 ] , … , {e}_{m} [ N ] ]}^{T} = - [ \begin{matrix}\overline{M} & \text{-} \overline{M}\end{matrix} ] \cdot λ & 38 \\ {X}_{p} = {[ {e}_{p} [ 1 ] , {e}_{p} [ 2 ] , … , {e}_{p} [ N ] ]}^{T} & 39 \\ z = [ \begin{matrix}{X}_{u} \\ - {X}_{1}\end{matrix} ] - [ \begin{matrix}{X}_{p} \\ - {X}_{p}\end{matrix} ] & 40 \\ q = [ \begin{matrix}{X}_{u} \\ - {X}_{1}\end{matrix} ] - [ \begin{matrix}{X}_{b} \\ - {X}_{b}\end{matrix} ] & 41 \\ z = M \cdot λ + q & 42 \\ {λ}^{T} \cdot z = 0 & 43 \\ λ ≧ 0 & 44 \\ z ≧ 0 & 45\end{matrix}$$

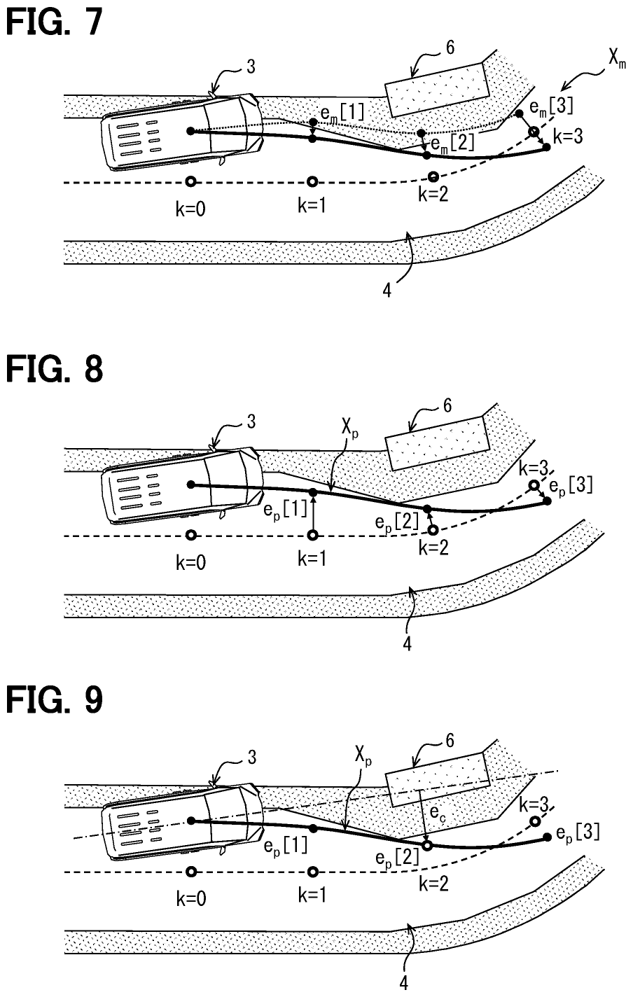

Therefore, the correction calculation block 140 calculates the correction vector λ by the N-step scheme in which the number N of time-series points on the correction trajectory Xₘ is the maximum calculation step number for each constraint type of future traveling. According to this N-step scheme, even when a constraint condition is considered for a plurality of motion physical quantities including the lateral position e[k], that is, even when a plurality of types of constraints are considered, the number of calculation steps of the correction vector A is limited by the number N of time series points for each constraint type. The correction calculation block 140 further calculates the correction trajectory Xₘ of equation 38 using the calculation result of the correction vector λ. FIG. 7 shows an example of the correction trajectory Xₘ calculated in consideration of the constraint when the constraint on the vehicle 3 is to avoid the obstacle 6, together with the lateral position correction amount eₘ[k] at each time series point.

The target calculation block 160 shown in FIG. 2 superimposes the correction trajectory Xₘ calculated by the correction calculation block 140 on the standard trajectory X_{b} calculated by the standard calculation block 100 according to equation 46. With this superimposition, the target calculation block 160 calculates the target trajectory Xₚ of the lateral position eₚ[k] defined by the equation 46 as the traveling trajectory X to be followed by the vehicle 3 by outputting to the driving control device 2. FIG. 8 shows an example of a target trajectory Xₚ obtained by modifying the standard trajectory X_{b} with the correction trajectory Xₘ in consideration of the constraint when the constraint on the vehicle 3 is to avoid the obstacle 6, together with the lateral position eₚ[k] at each time series point.

(Equation 46)

Xₚ=[eₚ[1],eₚ[2], . . . ,eₚ[N]]^{T}=X_{b}+Xₘ [symbol] 46

The driving control device 2 shown in FIGS. 1 and 3 selects at least one of the time-series points included in the target trajectory Xₚ output from the target calculation block 160 as a control point. The driving control device 2 extracts the distance e_{c} from the lateral position eₚ[k] of the selected control point to the center line of the vehicle 3 in the width direction as shown in FIG. 9. Therefore, the driving control device 2 calculates the target steering angle δₜ applying to the vehicle 3 by the following equation 47 so as to reduce the extracted distance e_{c} as a tracking error. The driving control device 2 calculates the steering torque T for controlling the vehicle 3 to follow the target trajectory Xₚ by the following equation 48 using the calculated target steering angle δₜ and the actual steering angle δ_{w} of the vehicle 3. g in equation 47 and gₚ, g_{d}, and gᵢ in equation 48 are adaptive parameters for tracking control that are set to appropriate values.

$$\begin{matrix}[ Equations 47 and 48 ] & \\ {δ}_{t} = g \cdot {e}_{c} & 47 \\ T = - {g}_{p} \cdot ( {δ}_{w} - {δ}_{t} ) - {g}_{d} \cdot ( \frac{d {δ}_{w}}{dt} - \frac{d {δ}_{t}}{d t} ) - {g}_{i} \cdot \int ( {δ}_{w} - {δ}_{t} ) dt & 48\end{matrix}$$

From the above, the standard calculation block 100 corresponds to the “standard calculator”, the correction calculation block 140 corresponds to the “correction calculator”, and the target calculation block 160 corresponds to the “target calculator”.

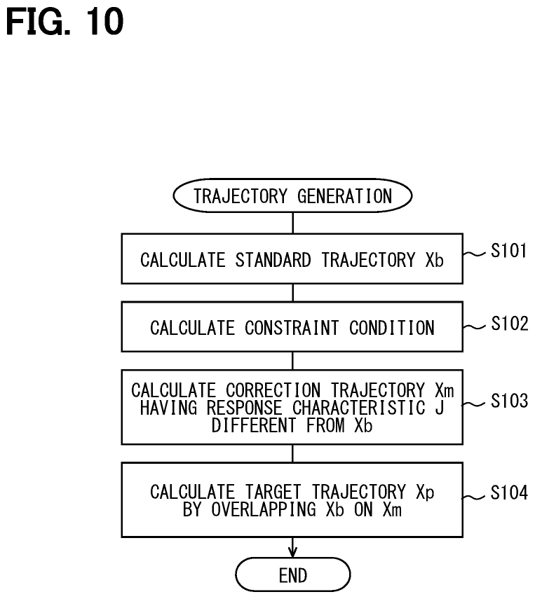

The flow of the trajectory generation method in which the trajectory generator 1 generates the traveling trajectory X in cooperation with the functional blocks 100, 120, 140, 160 described above will be described below with reference to FIG. 10. It should be noted that this flow is started each time the vehicle 3 reaches the time series point where k is 0. Further, in this flow, “S” means a plurality of steps of the flow executed by a plurality of instructions included in the trajectory generation program.

In S101, the standard calculation block 100 calculates the standard trajectory X_{b} based on the standard response parameter as the traveling trajectory X that does not consider the constraint condition for future traveling. In S102, the constraint calculation block 120 calculates the constraint condition given to the vehicle 3 in the future traveling.

In S103, the correction calculation block 140 calculates the correction trajectory Xₘ based on the response parameter different from the standard trajectory X_{b} as the travel trajectory X of with correction amount for correcting the standard trajectory X_{b} calculated in S101 in time series according to the constraint condition calculated in S102. In S104, the target calculation block 160 calculates the target trajectory Xₚ which the vehicle 3 follows as the traveling trajectory X in which the correction trajectory Xₘ calculated in S103 is superimposed on the standard trajectory X_{b} calculated in S101. Although the present flow ends as described above, the target track Xₚ calculated in S104 is output to the driving control device 2, so that the vehicle 3 is controlled to follow the target track X.

(Functions and Effects)

The functions and effects in the present embodiment described above will be explained below.

According to the present embodiment, the correction trajectory Xₘ is calculated using the response parameter different from the standard trajectory X_{b}, as the correction amount of the travelling trajectory X for correcting the standard trajectory X_{b} that is obtained without considering the constraint condition in the future travelling, in the time series according to the constraint condition. As a result, the constraint condition can be reflected at once in the calculation of the correction trajectory Xₘ regardless of the type thereof. Therefore, it is possible to reduce the calculation load until the target trajectory Xₚ is generated by superimposing the correction trajectory Xₘ on the standard trajectory X_{b}.

According to this embodiment, the correction trajectory Xₘ is calculated so that the response characteristic is changed to be a steeper side than the standard trajectory X_{b}. Accordingly, the correction trajectory Xₘ having a different response parameter from the standard trajectory X_{b} can satisfy the constraint condition even with a small number of calculations. Therefore, it is possible to contribute to the reduction of the calculation load until the target trajectory Xₚ is generated.

According to the present embodiment, the corrected trajectory Xₘ is calculated so as to provide the response characteristic in which the operation quantity u[k] for the vehicle 3 is larger than the standard trajectory X_{b}. According to this, the correction trajectory Xₘ having a response characteristic steeper than that of the standard trajectory X_{b} can be accurately calculated even with a small number of calculations, and the constraint condition can be satisfied. Therefore, it is possible to reduce the calculation load until the target trajectory Xₚ is generated, while ensuring the generation accuracy thereof.

According to the present embodiment, the correction trajectory Xₘ is calculated so that the N step vector p exists as a condition for establishing the N step scheme in which the number N of time series points becomes the maximum number of calculation steps for each constraint type of future traveling. As a result, the number of calculations for the correction trajectory Xₘ can be suppressed. Here, in particular, even in the present embodiment in which the constraint conditions regarding the lateral position e[k] and the yaw angle θ[k] other than the lateral position are taken into consideration, the effect of suppressing the number of calculations can be obtained. From these, it becomes possible to contribute to the reduction of the calculation load until the target trajectory Xₚ is generated.

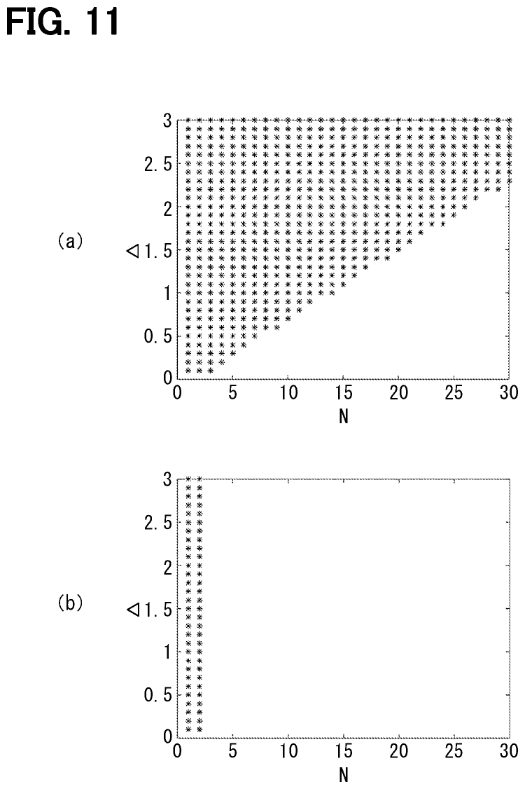

FIG. 11 shows, for each of the present embodiment (a) and the comparative example (b), among the time series points where k is 0 or more, the time series points at which the correction trajectory Xₘ can be calculated with the total number N or less by black circles. In FIG. 11, the larger the value of the time interval A on the vertical axis, the farther the time series point that can be calculated is disposed. Compared to the comparative example in which the parameter matrix Q_{b} and the parameter coefficient R_{b} are directly set to the parameter matrix Qₘ and the parameter coefficient Rₘ according to the above-mentioned conceivable technique, in the present embodiment with the different settings, the time series points at which the correction trajectory Xₘ can be calculated increases far from zero point. This indicates that the correction trajectory Xₘ can be calculated in the present embodiment even if the maximum number of calculation steps in the N-step scheme is restricted to the number N of the time series points so that the number of calculations is small.

### Other Embodiments

Although one embodiment has been described, the present disclosure should not be limited to the above embodiment and may be applied to various other embodiments within the scope of the present disclosure.

Specifically, the trajectory generator 1 of the modification may be a special purpose computer configured to include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like.

Such a digital circuit may include a memory in which a program is stored.

In the modification under the condition that the equation 1 is satisfied, the equation 17 is replaced with the equation 31 so that the standard trajectory, the correction trajectory, and the target trajectory regarding the yaw angle θ[k] may be calculated according to the principle similar to the above embodiment. Alternatively, in a modification under the condition that the equation 1 is satisfied, equations 23 and 24 are replaced with equations 49 and 50 (in which I is an unit matrix), respectively, so that the standard trajectory, the correction trajectory and the target trajectory relating to the curvature correction amount kᵥ[k]−kₚ[k] may be calculated according to the principle similar to the above embodiment. Further, in the latter modification, the curvature correction amount Kᵥ[k]−Kₚ[k] and its constraint condition are converted into the steering angle, so that the standard trajectory, the correction trajectory, and the target trajectory related to the steering angle may be calculated.

$$\begin{matrix}[ Equations 49 and 50 ] & \\ \tilde{A} = [ \begin{matrix}O \\ O\end{matrix} ] & 49 \\ \tilde{B} = [ \begin{matrix}I \\ - I\end{matrix} ] & 50\end{matrix}$$

The following equation 51 is established between the traveling distance s[k] and the traveling speed v[k] which are the state quantities of the vehicle 3 and the acceleration a[k] which is the operation quantity of the vehicle 3. In the modification under the condition that the equation 51 is satisfied, the equation 17 is replaced with the equation 31 so that the standard trajectory, the correction trajectory, and the target trajectory regarding the travelling speed v[k] may be calculated according to the principle similar to the above embodiment. Alternatively, in a modification under the condition that the equation 51, is satisfied, the equation 23 and the equation 24 are replaced with the equation 49 and the equation 50, respectively, so that the standard trajectory, the correction trajectory, and the target trajectory relating to the acceleration a[k] may be calculated according to the principle similar to the above-described embodiment.

$$\begin{matrix}[ Equation 51 ] & \\ [ \begin{matrix}s [ k + 1 ] \\ v [ k + 1 ]\end{matrix} ] = [ \begin{matrix}1 & Δ \\ 0 & 1\end{matrix} ] \cdot [ \begin{matrix}s [ k ] \\ v [ k ]\end{matrix} ] + [ \begin{matrix}{Δ}^{2} / 2 \\ Δ\end{matrix} ] \cdot a [ k ] & 51\end{matrix}$$

In the modification, in order to make the response characteristic of the correction trajectory Xₘ different from that of the standard trajectory X_{b}, when the variation matrix δM that changes the correction matrix M is defined, the following equation 52 using the positive parameter coefficient ε may perturb the correction matrix M within the range where equation 37 is satisfied. Also in this modification, based on the correction matrix M that makes the response parameter different from the standard by the perturbation, the correction vector λ that satisfies equations 40 to 45 is calculated, and the correction trajectory Xₘ of equation 38 is can be calculated using the result of the correction vector calculation.

(Equation 52)

M←M+ε·δM [symbol] 52

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A trajectory generator for generating a traveling trajectory in which a physical quantity of motion of a vehicle in future traveling is specified in time series, the trajectory generator comprising:
a standard calculator that calculates a standard trajectory based on a standard response parameter as a traveling trajectory that does not consider a constraint condition in the future traveling;
a correction calculator that calculates a correction trajectory based on a correction response parameter different from the standard trajectory as a traveling trajectory having a correction amount for correcting the standard trajectory in time series according to the constraint condition; and
a target calculator that calculates a target trajectory to which the vehicle follows, as a traveling trajectory in which the correction trajectory is superimposed on the standard trajectory.

2. The trajectory generator according to claim 1, further comprising:
one or more processors; and
a memory coupled to the one or more processors and storing program instructions that when executed by the one or more processors cause the one or more processors to provide at least: a standard calculator; a correction calculator;
and a target calculator.

3. The trajectory generator according to claim 1, wherein:
the correction calculator calculates the correction trajectory so as to change a response characteristic to be steeper than the standard trajectory.

4. The trajectory generator according to claim 3, wherein:
the correction calculator calculates the correction trajectory so as to provide a response characteristic for providing an operation amount with respect to the vehicle to be larger than the standard trajectory.

5. The trajectory generator according to claim 1, wherein:
the correction calculator calculates the correction trajectory so as to present an N step vector as a condition for establishing an N step scheme in which a numerical number of time-series points on the correction trajectory becomes a maximum number of calculation steps for each constraint type of the future traveling.

6. The trajectory generator according to claim 1, wherein:
the constraint condition is a condition for restricting a lateral position and a yaw angle of the physical quantity of motion of the vehicle relative to a traveling path.

7. The trajectory generator according to claim 1, wherein:
the constraint condition includes a plurality of types of constraint; and
the correction trajectory is calculated based on the plurality of types of constraint.

8. A trajectory generating method executed by a processor for generating a traveling trajectory in which a physical quantity of motion of a vehicle in future traveling is specified in time series, the trajectory generating method comprising:
calculating a standard trajectory based on a standard response parameter as a traveling trajectory that does not consider a constraint condition in future traveling;
calculating a correction trajectory based on a correction response parameter different from the standard trajectory as a traveling trajectory having a correction amount for correcting the standard trajectory in time series according to the constraint condition; and
calculating a target trajectory to which the vehicle follows, as a traveling trajectory in which the correction trajectory is superimposed on the standard trajectory.

9. The trajectory generating method according to claim 8, wherein:
the correction trajectory is calculated so as to change a response characteristic to be steeper than the standard trajectory.

10. The trajectory generating method according to claim 9, wherein:
the correction trajectory is calculated so as to provide a response characteristic for providing an operation amount with respect to the vehicle to be larger than the standard trajectory.

11. The trajectory generating method according to claim 8, wherein:
the correction trajectory is calculated so as to present an N step vector as a condition for establishing an N step scheme in which a numerical number of time-series points on the correction trajectory becomes a maximum number of calculation steps for each constraint type of the future traveling.

12. The trajectory generating method according to claim 8, wherein:
the constraint condition is a condition for restricting a lateral position and a yaw angle of the physical quantity of motion of the vehicle relative to a traveling path.

13. The trajectory generating method according to claim 8, wherein:
the constraint condition includes a plurality of types of constraint; and
the correction trajectory is calculated based on the plurality of types of constraint.

14. A non-transitory tangible computer readable storage medium comprising instructions being executed by a computer, the instructions including a computer-implemented method for generating a traveling trajectory in which a physical quantity of motion of a vehicle in future traveling is specified in time series,
the instructions include:
calculating a standard trajectory based on a standard response parameter as a traveling trajectory that does not consider a constraint condition in future traveling;
calculating a correction trajectory based on a correction response parameter different from the standard trajectory as a traveling trajectory having a correction amount for correcting the standard trajectory in time series according to the constraint condition; and
calculating a target trajectory to which the vehicle follows, as a traveling trajectory in which the correction trajectory is superimposed on the standard trajectory.

15. The non-transitory tangible computer readable storage medium according to claim 14, wherein:
the correction trajectory is calculated so as to change a response characteristic to be steeper than the standard trajectory.

16. The non-transitory tangible computer readable storage medium according to claim 15, wherein:
the correction trajectory is calculated so as to provide a response characteristic for providing an operation amount with respect to the vehicle to be larger than the standard trajectory.

17. The non-transitory tangible computer readable storage medium according to claim 14, wherein:
the correction trajectory is calculated so as to present an N step vector as a condition for establishing an N step scheme in which a numerical number of time-series points on the correction trajectory becomes a maximum number of calculation steps for each constraint type of the future traveling.

18. The non-transitory tangible computer readable storage medium according to claim 14 wherein:
the constraint condition is a condition for restricting a lateral position and a yaw angle of the physical quantity of motion of the vehicle relative to a traveling path.

19. The non-transitory tangible computer readable storage medium according to claim 14, wherein:
the constraint condition includes a plurality of types of constraint; and
the correction trajectory is calculated based on the plurality of types of constraint.
